(19) United States
(12) Patent Application Publication
(10) Pub. No.: US 2024/0416614 A1
(43) Pub. Date: Dec. 19, 2024

(54) DISPLAY DEVICE INCLUDING A WINDOW AND A METHOD OF MANUFACTURING THE WINDOW

(71) Applicant: SAMSUNG DISPLAY CO., LTD., YONGIN-SI (KR)

(72) Inventors: JAE HOON JEONG, Yongin-si (KR); MYUNG-HWAN KIM, Yongin-si (KR); IK HYUNG PARK, Yongin-si (KR); KYUNGEUN LEE, Yongin-si (KR); YOUNG SUK KIM, Yongin-si (KR); SEUNG JUN YI, Yongin-si (KR); KYUNG HEE CHOI, Yongin-si (KR)

(21) Appl. No.: 18/732,864

(22) Filed: Jun. 4, 2024

(30) Foreign Application Priority Data
Jun. 13, 2023 (KR) 10-2023-0075755

(51) Int. Cl. B32B 3/26

(52) U.S. Cl. CPC B32B 3/263; B32B 2255/26; B32B 2307/7376; B32B 2457/20

(57) ABSTRACT

A display device including: a substrate including a bending area, a boundary area adjacent to the bending area, and a non-bending area adjacent to the boundary area; and a window disposed on the substrate and including: a base substrate including a first surface having a slope of about 0.10 to about 0.9° in the boundary area with respect to the first surface in the bending area, wherein the base substrate has a thickness in the bending area that is less than its thickness in the non-bending area; and a coating layer disposed on a second surface of the base substrate, wherein the second surface faces the first surface of the base substrate.

### CROSS-REFERENCE TO RELATED APPLICATION(S)

This application claims priority under 35 U.S.C. § 119 to Korean Patent Application No. 10-2023-0075755 filed on Jun. 13, 2023, in the Korean Intellectual Property Office (KIPO), the disclosure of which is incorporated by reference herein in its entirety.

### 1. TECHNICAL FIELD

Embodiments of the present disclosure relate to a display device including a window and a method of manufacturing the window.

### 2. DESCRIPTION OF THE RELATED ART

Recently, there has been a development of flexible display devices capable of transforming into various shapes. Unlike flat panel displays, these devices can be folded, bent, or rolled much like paper. Such flexibility not only makes them more portable, but also increases user convenience.

The flexible display device typically includes a display panel with flexible properties, accompanied by a protective window. The window is essential to protect the display panel from external impacts, while simultaneously ensuring that the device's ability to fold, bend or roll is not hindered.

### SUMMARY

Embodiments of the present disclosure provide a display device including a window with improved reliability.

Embodiments of the present disclosure provide a method of manufacturing the window.

An embodiment of the present disclosure provides a display device including: a substrate including a bending area, a boundary area adjacent to the bending area, and a non-bending area adjacent to the boundary area; and a window disposed on the substrate and including: a base substrate including a first surface having a slope of about 0.1° to about 0.9° in the boundary area with respect to the first surface in the bending area, wherein the base substrate has a thickness in the bending area that is less than its thickness in the non-bending area; and a coating layer disposed on a second surface of the base substrate, wherein the second surface faces the first surface of the base substrate.

A width of the window in the boundary area is about 1 mm to about 20 mm.

An edge of at least one of the first surface and the second surface of the base substrate has a chamfered shape in the bending area and the boundary area.

The slope of the first surface of the base substrate is constant in the boundary area.

The slope of the first surface of the base substrate varies at least once in the boundary area.

The boundary area includes a first area adjacent to the bending area, a second area adjacent to the non-bending area, and a third area between the first area and the second area, and a slope of the third area of the base substrate is greater than a slope of each of the first area and the second area of the base substrate.

A width of the window in the third area is greater than a sum of a width of the window in the first area and a width of the window in the second area.

An embodiment of the present disclosure provides a method of manufacturing a window, the method including: immersing a bending area and a boundary area of a base substrate into an etchant, wherein the boundary area is adjacent to the bending area and the boundary area is adjacent to a non-bending area of the base substrate; and removing the base substrate from the etchant so that a first surface of the base substrate has a slope in the boundary area.

The removing of the base substrate includes forming an edge of at least one of the first surface and a second surface of the base substrate facing the first surface to have a chamfered shape in the bending area and the boundary area.

The first surface is formed to have the slope of about 0.10 to about 0.9° in the boundary area with respect to the first surface in the bending area.

A width of the boundary area is formed to be about 1 mm to about 20 mm.

In the removing of the base substrate, a speed of removing the boundary area of the base substrate from the etchant is constant.

In the removing of the base substrate, a speed of removing the boundary area of the base substrate from the etchant varies at least once.

The boundary area includes a first area adjacent to the bending area, a second area adjacent to the non-bending area, and a third area between the first area and the second area, and a slope of the third area is formed to be greater than a slope of each of the first area and the second area.

A width of the third area is formed to be greater than a sum of a width of the first area and a width of the second area.

The removing of the base substrate includes discharging or flowing the etchant.

In the immersing of the bending area and the boundary area of the base substrate in the etchant, the base substrate is tilted and immersed.

The method further includes forming a coating layer on a second surface of the base substrate facing the first surface of the base substrate before the immersing of the bending area and the boundary area of the base substrate in the etchant.

The method further includes forming an inorganic layer between the second surface and the coating layer before the immersing of the bending area and the boundary area of the base substrate in the etchant.

The method further includes healing the bending area, the boundary area, and the non-bending area of the base substrate by immersing the bending area, the boundary area, and the non-bending area of the base substrate in the etchant.

In a display device according to embodiments of the present disclosure, the display device may include a window having a slope in a boundary area. Since the window has a relatively small slope in the boundary area, a step between a thickness in a bending area and a thickness in a non-bending area may not be visibly recognized. Accordingly, an impact resistance of the display device may be improved, and a repulsive force of the display device may be reduced, thereby improving the durability of the display device. In addition, the window may be formed by immersing a portion of the window in an etchant and controlling a speed at which the window is taken out from the etchant. Accordingly, a manufacturing process of the window may be simplified, and process efficiency may be improved.

### BRIEF DESCRIPTION OF THE DRAWINGS

FIGS. 1 and 2 are perspective views illustrating a display device according to an embodiment of the present disclosure.

FIG. 3 is a cross-sectional view illustrating the display device of FIG. 1.

FIG. 4 is a cross-sectional view of a window included in the display device of FIG. 1 taken along line I-I′.

FIG. 5 is a cross-sectional view of a window included in the display device of FIG. 1 taken along lines II-II′, III-III′ and IV-IV′.

FIGS. 6, 7, 8, 9 and 10 are views illustrating an embodiment of a method of manufacturing the window of FIG. 4.

FIGS. 11, 12, 13 and 14 are views illustrating another embodiment of a method of manufacturing the window of FIG. 4.

FIGS. 15, 16, 17, 18 and 19 are views illustrating still another embodiment of a method of manufacturing the window of FIG. 4.

FIG. 20 is a cross-sectional view illustrating a display device according to another embodiment of the present disclosure.

FIG. 21 is a cross-sectional view illustrating a window included in the display device of FIG. 20.

FIG. 22 is an enlarged cross-sectional view of area A of FIG. 21.

FIGS. 23, 24, 25 and 26 are views illustrating an embodiment of a method of manufacturing the window of FIG. 21.

FIG. 27 is a cross-sectional view illustrating a display device according to still another embodiment of the present disclosure.

FIGS. 28 and 29 are cross-sectional views illustrating a window included in the display device of FIG. 27.

FIGS. 30, 31, 32, 33, 34, 35, 36, 37 and 38 are views illustrating an embodiment of a method of manufacturing the window of FIG. 27.

FIG. 39 is a cross-sectional view illustrating a display device according to still another embodiment of the present disclosure.

FIG. 40 is a cross-sectional view illustrating a window included in the display device of FIG. 39.

### DETAILED DESCRIPTION OF THE EMBODIMENTS

Hereinafter, embodiments of the present disclosure will be described in more detail with reference to the accompanying drawings. The same reference numerals may refer to the same components in the drawings, and thus, redundant descriptions of the same components may be omitted.

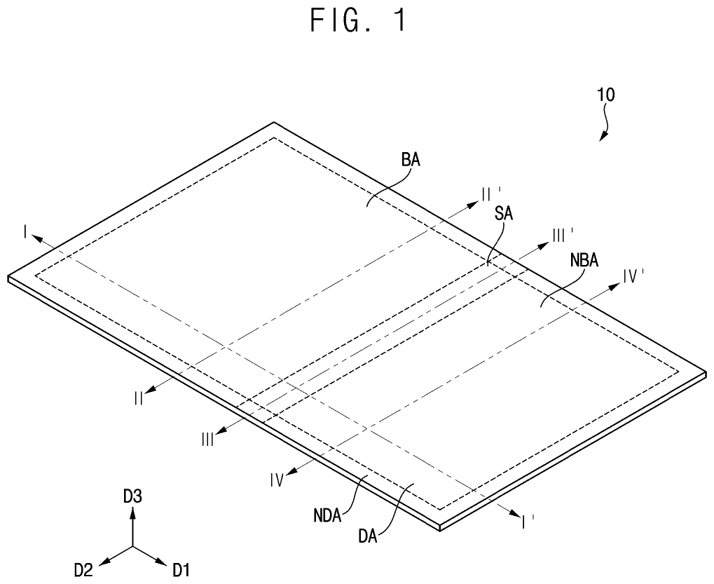

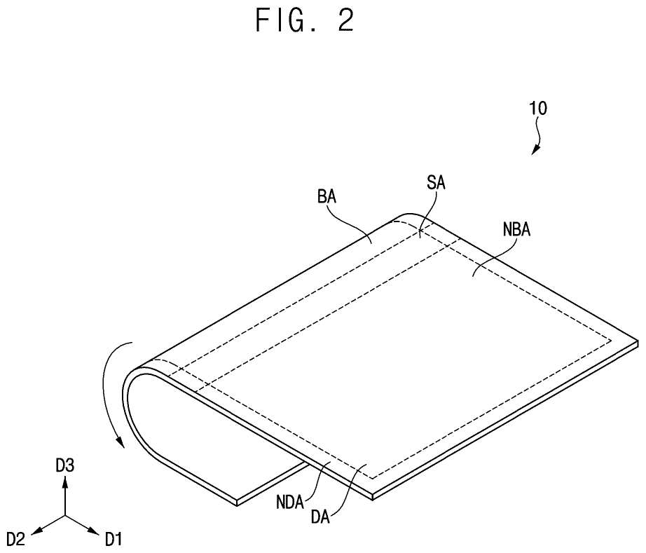

FIGS. 1 and 2 are perspective views illustrating a display device according to an embodiment of the present disclosure. For example, FIG. 1 may be a perspective view illustrating a display device 10 in an unbent state, and FIG. 2 may be a perspective view illustrating the display device 10 in a bent state.

Referring to FIGS. 1 and 2, the display device 10 may include a display area DA and a non-display area NDA.

The display area DA may be an area that displays an image by generating light. A plurality of pixels that emit light may be disposed in the display area DA, and accordingly, the image may be displayed in the display area DA. The pixels may be arranged in a matrix form along a first direction D1 and a second direction D2 intersecting the first direction D1. For example, the second direction D2 may be perpendicular to the first direction D1. In this case, the image may be displayed in the display area DA in a third direction D3 perpendicular to each of the first direction D1 and the second direction D2. The third direction D3 may correspond to a thickness direction of the display device 10.

The non-display area NDA may be an area that does not display an image. The non-display area NDA may surround at least a portion of the display area DA. For example, the non-display area NDA may entirely surround the display area DA. As another example, the non-display area NDA may be disposed on only one side of the display area DA.

The display device 10 may be a flexible display device. The display device 10 may include a bending area BA and a non-bending area NBA. The bending area BA and the non-bending area NBA may be spaced apart from each other. For example, the bending area BA and the non-bending area NBA may be spaced apart from each other along the first direction D1 in the unbent state. In addition, the display device 10 may include a boundary area SA located between the bending area BA and the non-bending area NBA. For example, the bending area BA, the boundary area SA and the non-bending area NBA may be arranged in sequence. In other words, the boundary area SA may be adjacent to the bending area BA in the first direction D1, and the non-bending area NBA may be adjacent to the boundary area SA in the first direction D1.

The bending area BA may be an area where the display device 10 is bent, and the non-bending area NBA may be an area where the display device 10 is not bent. The bending area BA may be bent to have a curvature. The boundary area SA may be an area where the display device 10 is bent, or may be an area where the display device 10 is not bent. As an example, the boundary area SA may be partially flexible.

In FIGS. 1 and 2, the display device 10 is illustrated as including one bending area BA and is bent once, but the present disclosure is not limited thereto. For example, the display device 10 may include two or more bending areas BA, and may be bent two or more times.

In addition, in FIGS. 1 and 2, the display device 10 is illustrated as being bent in the first direction D1, but the present disclosure is not limited thereto. For example, the display device 10 may be bent in the second direction D2. Furthermore, the display device 10 may be bent to partially cover the display area DA.

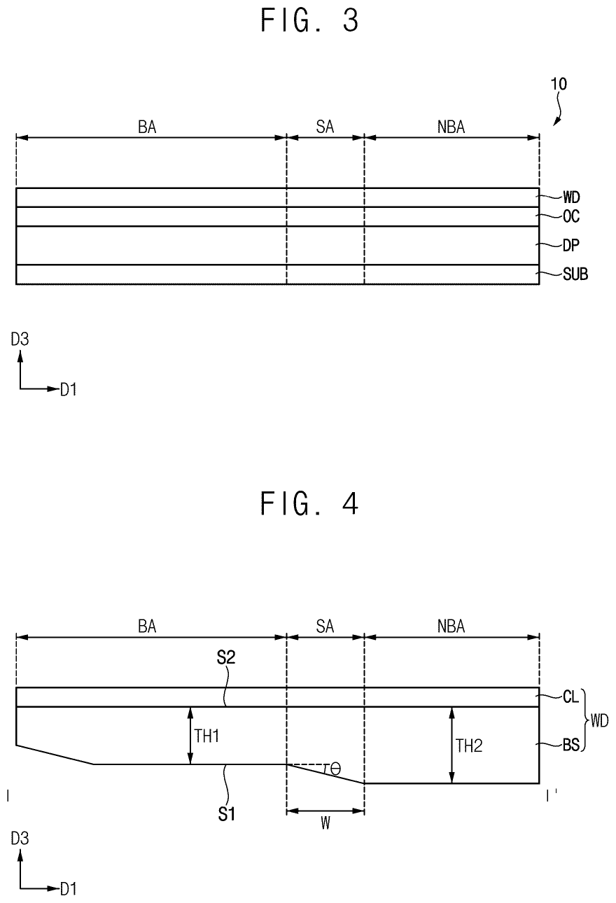

FIG. 3 is a cross-sectional view illustrating the display device of FIG. 1.

Referring to FIG. 3, the display device 10 may include a substrate SUB, a display portion DP, an overcoating layer OC, and a window WD. The substrate SUB, the display portion DP, the overcoating layer OC, and the window WD may be arranged in sequence.

The substrate SUB may include a transparent material or an opaque material. Examples of materials that may be used as the substrate SUB may include polyimide, quartz, glass, or the like. These may be used alone or in combination with each other.

The display portion DP may be disposed on the substrate SUB. For example, the display portion DP may be in direct contact with an upper surface of the substrate SUB. The display portion DP may display the image by including the pixels. In other words, the display portion DP may display the image by emitting light toward an upper surface spaced apart from the substrate SUB (e.g., in the third direction D3).

The overcoating layer OC may be disposed on the display portion DP. The overcoating layer OC may bond the window WD to the display portion DP without any empty space therebetween. A refractive index of the overcoating layer OC may be similar to or identical to a refractive index of the window WD. The overcoating layer OC may include an organic insulating material. Examples of organic insulating materials that may be used as the overcoating layer OC may include photoresist, polyacrylic resin, polyimide resin, acrylic resin, or the like. These may be used alone or in combination with each other.

The window WD may be disposed on the overcoating layer OC. The window WD may block foreign substances penetrating from an outside, and may prevent impacts applied from the outside from being transmitted to components disposed below the window WD. In other words, the window WD may protect the components of the display device 10.

In an embodiment, a functional coating layer may be further disposed between the overcoating layer OC and the window WD. In this case, the window WD may not be in direct contact with the overcoating layer OC. The functional coating layer may be composed of a single layer or multiple layers. The functional coating layer may include an optical coating layer to improve a visibility of the display device 10, a primer coating layer to improve adhesion between the overcoating layer OC and the window WD, a high-strength coating layer to improve impact resistance of the display device 10, or the like.

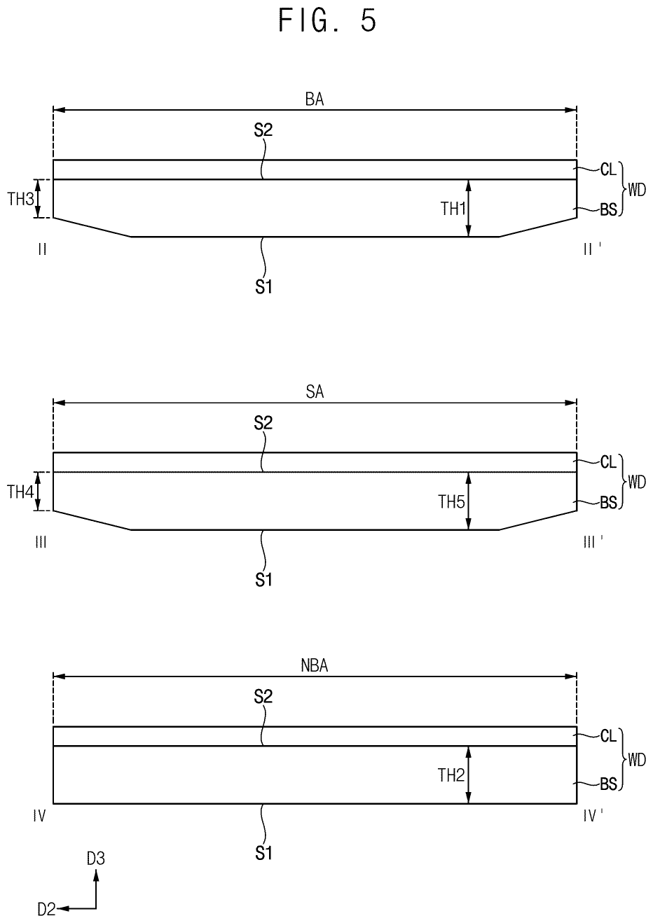

FIG. 4 is a cross-sectional view of a window included in the display device of FIG. 1 taken along line I-I′. FIG. 5 is a cross-sectional view of a window included in the display device of FIG. 1 taken along lines II-II′, III-III′ and IV-IV′.

Referring to FIGS. 4 and 5, the window WD may include a base substrate BS and a coating layer CL.

The base substrate BS may include a first surface S1 and a second surface S2 facing the first surface S1. For example, the first surface S1 may be a lower surface of the base substrate BS, and the second surface S2 may be an upper surface of the base substrate BS. In an embodiment, the first surface S1 may have a step, and the second surface S2 may be substantially flat. For example, the first surface S1 may have at least one slanted portion.

In an embodiment, a thickness TH1 of the base substrate BS in the bending area BA may be thinner than a thickness TH2 of the base substrate BS in the non-bending area NBA. A thickness of the base substrate BS in the boundary area SA may be in between the thickness TH1 of the base substrate BS in the bending area BA and the thickness TH2 of the base substrate BS in the non-bending area NBA.

In an embodiment, a width W of the boundary area SA of the base substrate BS may be about 1 mm to about 20 mm. In addition, the first surface S1 of the base substrate BS may have a slope θ in the boundary area SA. For example, the first surface S1 of the base substrate BS may have the slope θ of about 0.1° to about 0.9° in the boundary area SA with respect to the first surface S1 of the base substrate BS in the bending area BA. In an embodiment, the slope θ may be constant.

In an embodiment, an edge of the first surface S1 of the base substrate BS in the bending area BA and the boundary area SA may have a chamfered shape.

In other words, in the bending area BA, a thickness TH3 of the edge of the base substrate BS may be thinner or equal to the thickness TH1 of the base substrate BS. For example, in the bending area BA, the thickness TH3 of the edge of the base substrate BS may be about 60% to about 100% of the thickness TH1 of the base substrate BS.

In addition, in the boundary area SA, a thickness TH4 of the edge of the base substrate BS may be thinner or equal to a thickness TH5 of the base substrate BS. For example, in the boundary area SA, the thickness TH4 of the edge of the base substrate BS may be about 60% to about 100% of the thickness TH5 of the base substrate BS.

The coating layer CL may be disposed on the base substrate BS. Specifically, the coating layer CL may be disposed on the second surface S2 of the base substrate BS. In other words, the coating layer CL may be in direct contact with the second surface S2 of the base substrate BS. For example, the coating layer CL may include a polymer film.

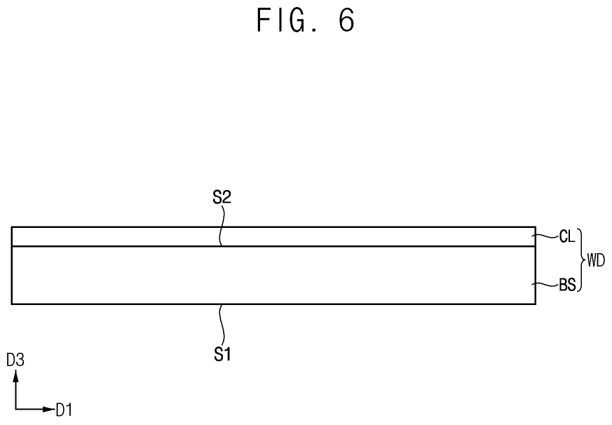

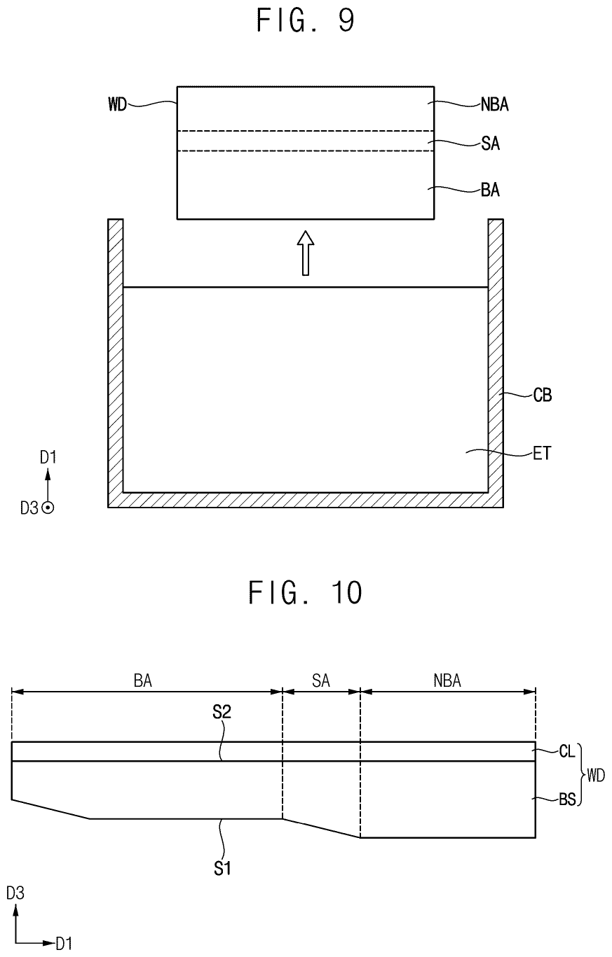

FIGS. 6, 7, 8, 9, and 10 are views illustrating an embodiment of a method of manufacturing the window of FIG. 4.

Referring to FIG. 6, the coating layer CL may be formed on the second surface S2 of the base substrate BS. Accordingly, the window WD including the base substrate BS and the coating layer CL may be formed.

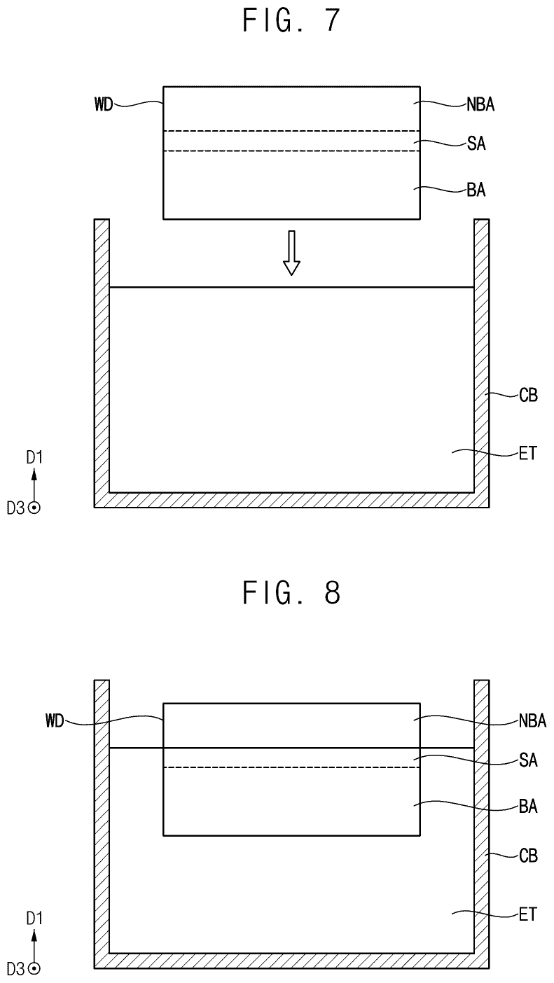

Referring to FIGS. 7 and 8, the window WD may be immersed in an etchant ET accommodated in an inner space of a chamber CB. The chamber CB may be a space where a process of etching the window WD is performed.

In an embodiment, only a portion of the window WD may be immersed in the etchant ET. For example, the bending area BA and the boundary area SA of the window WD may be immersed in the etchant ET. The non-bending area NBA of the window WD may not be immersed in the etchant ET.

As the window WD is immersed in the etchant ET, micro cracks existing on surfaces of the bending area BA and the boundary area SA of the window WD may be removed. Accordingly, a strength of the bending area BA and the boundary area SA of the window WD may be improved.

In an embodiment, the window WD may be tilted and immersed in the etchant ET. In other words, an angle formed between the etchant ET and the window WD may be less than about 90°. When the window WD is tilted and immersed, wettability between the window WD and the etchant ET may be relatively increased. Accordingly, time for etching the bending area BA and the boundary area SA of the window WD may be reduced.

Referring to FIGS. 8, 9, and 10, the window WD may be taken out from the etchant ET. For example, the window WD may be taken out by being moved in the first direction D1 from the etchant ET. In other words, the window WD may be removed from the chamber CB.

In an embodiment, a speed at which the boundary area SA of the window WD is taken out from the etchant ET may be controlled. For example, the boundary area SA of the window WD may be taken out at a constant speed. Accordingly, the first surface S1 of the base substrate BS may have the slope θ in the boundary area SA.

In addition, an edge of the first surface S1 of the base substrate BS immersed in the etchant ET may be formed to have a chamfered shape. In other words, the edge of the first surface S1 of the bending area BA and the boundary area SA of the base substrate BS may be etched to have the chamfered shape. Accordingly, the window WD in which the first surface S1 of the base substrate BS has a step may be manufactured.

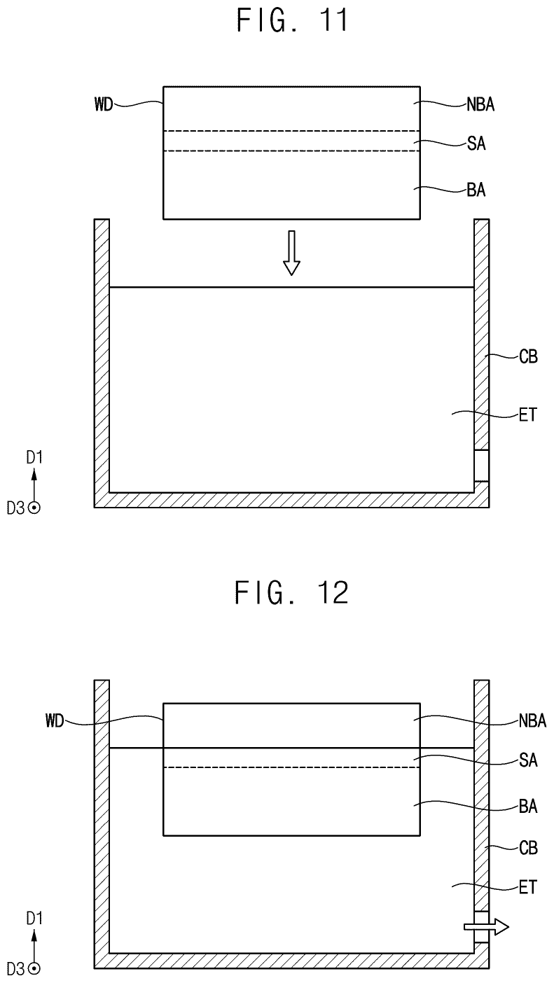

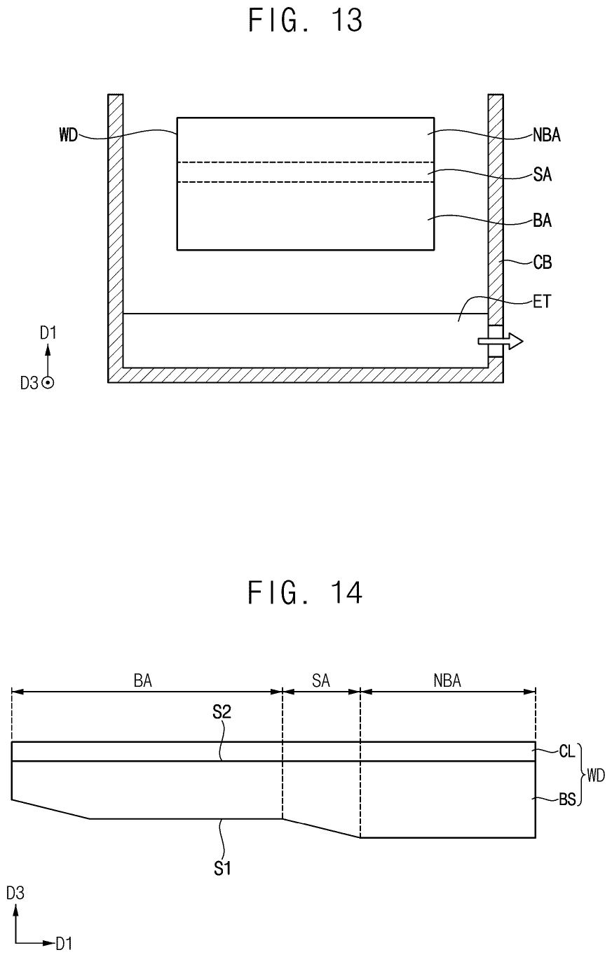

FIGS. 11, 12, 13, and 14 are views illustrating another embodiment of a method of manufacturing the window of FIG. 4.

A method of manufacturing the window WD described with reference to FIGS. 11, 12, 13, and 14 may be substantially the same as the method of manufacturing the window WD described with reference to FIGS. 6, 7, 8, 9, and 10, except for a method of removing the window WD from the etchant ET. Hereinafter, redundant descriptions will be omitted or simplified.

Referring to FIGS. 11 and 12, the bending area BA and the boundary area SA of the window WD may be immersed in the etchant ET, and the non-bending area NBA of the window WD may not be immersed in the etchant ET.

Referring to FIGS. 12, 13, and 14, the window WD may be removed from the etchant ET as the etchant ET is discharged from the chamber CB. For example, the etchant ET may be discharged through an opening near the bottom of the chamber CB.

In an embodiment, while the etchant ET passes through the boundary area SA of the window WD as the etchant ET is being discharged, a speed at which the etchant ET is discharged may be controlled. For example, the etchant ET may be discharged at a constant speed so that the first surface S1 of the base substrate BS may have the slope θ in the boundary area SA. Accordingly, the window WD in which the first surface S1 of the base substrate BS has a step may be manufactured.

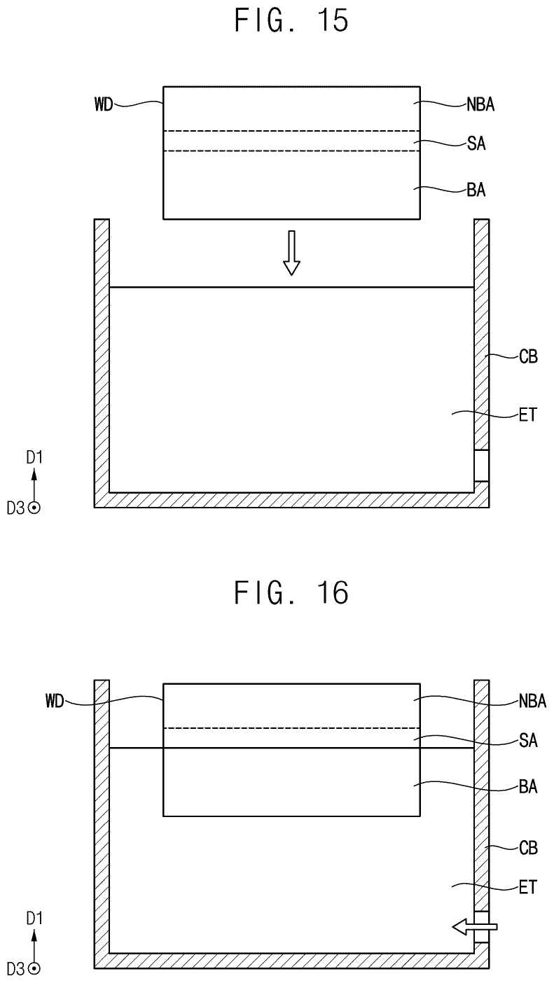

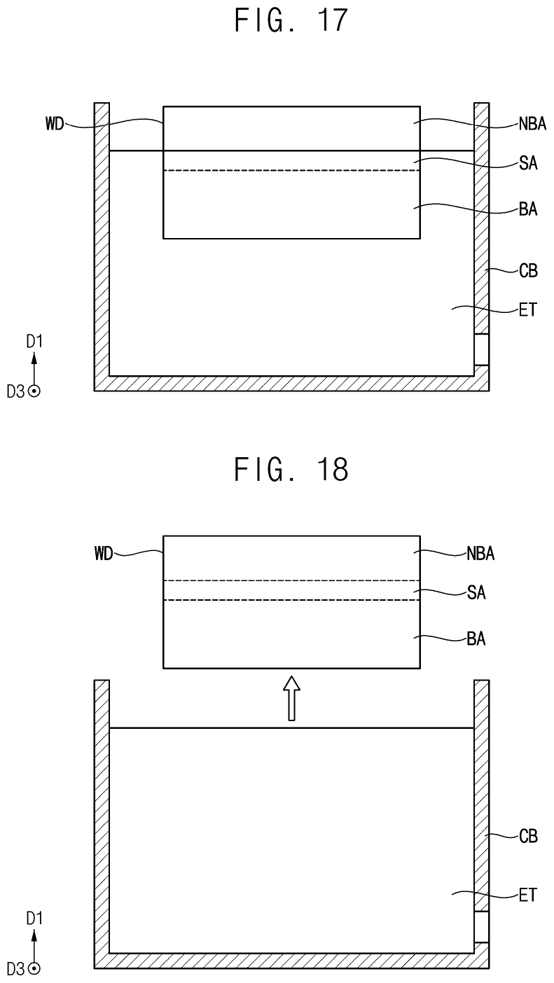

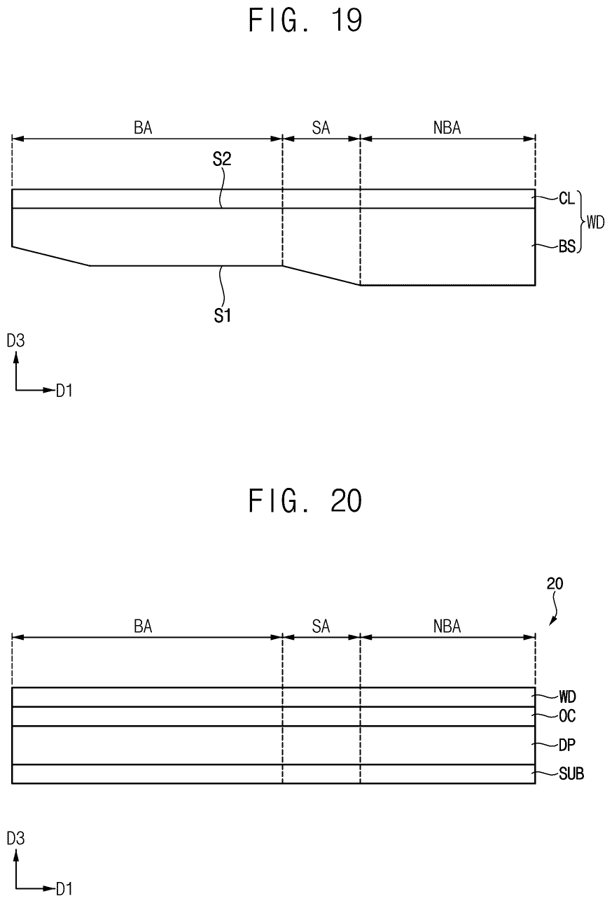

FIGS. 15, 16, 17, 18, and 19 are views illustrating still another embodiment of a method of manufacturing the window of FIG. 4.

A method of manufacturing the window WD described with reference to FIGS. 15, 16, 17, 18, and 19 may be substantially the same as the method of manufacturing the window WD described with reference to FIGS. 6, 7, 8, 9, and 10, except for a method of removing the window WD from the etchant ET. Hereinafter, redundant descriptions will be omitted or simplified.

Referring to FIGS. 15 and 16, a portion of at least one of the bending area BA and the boundary area SA of the window WD may be immersed in the etchant ET. In addition, the non-bending area NBA may not be immersed in the etchant ET. For example, at least a portion of the bending area BA of the window WD may be immersed in the etchant ET, and the boundary area SA of the window WD may not be immersed in the etchant ET. However, the present disclosure is not limited thereto. As another example, the bending area BA and a portion of the boundary area SA of the window WD may be immersed in the etchant ET.

Referring to FIGS. 16, 17, 18, and 19, the etchant ET may flow into the chamber CB. In other words, the etchant ET may flow into the chamber CB so that the bending area BA and the boundary area SA of the window WD can be immersed in the etchant ET.

In an embodiment, while the etchant ET passes over the boundary area SA of the window WD, a speed at which the etchant ET flows may be controlled. For example, the etchant ET may flow at a constant speed so that the first surface S1 of the base substrate BS may have the slope θ in the boundary area SA.

Then, the window WD may be removed from the etchant ET. For example, the window WD may be removed in the first direction D1 from the etchant ET. Accordingly, the window WD in which the first surface S1 of the base substrate BS has a step may be manufactured.

The display device 10 according to an embodiment of the present disclosure may include the window WD having the slope θ in the boundary area SA. Since the window WD has a relatively small slope θ in the boundary area SA, a step between the thickness TH1 in the bending area BA and the thickness TH2 in the non-bending area NBA may not be visually recognized. Accordingly, an impact resistance of the display device 10 may be improved, and a repulsion force of the display device 10 may be reduced. Therefore, a durability of the display device 10 may be improved. In addition, the window WD may be formed by immersing a portion of the window WD in the etchant ET and controlling the speed at which the window WD is removed from the etchant ET. Accordingly, a manufacturing process of the window WD may be simplified, and process efficiency may be improved.

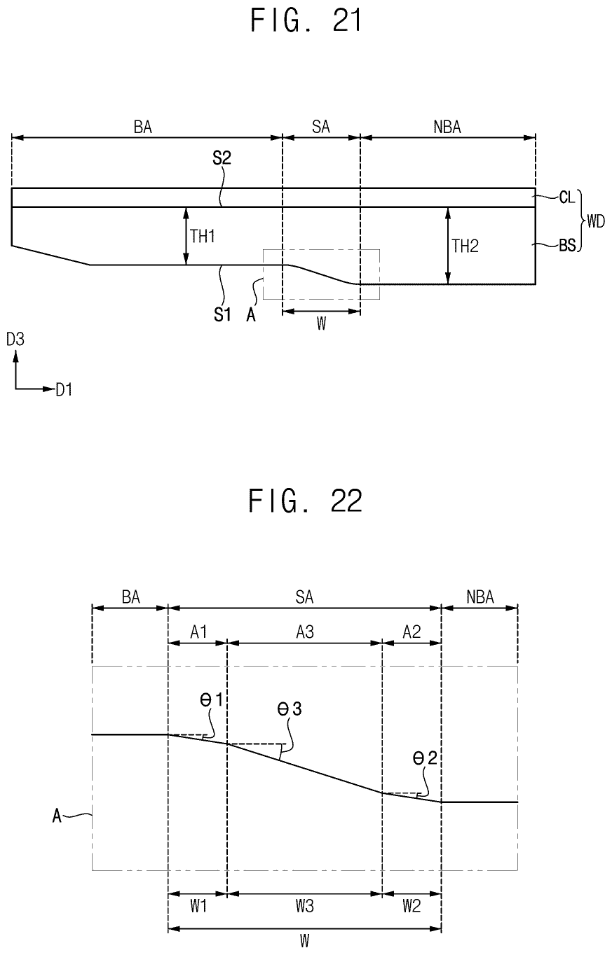

FIG. 20 is a cross-sectional view illustrating a display device according to another embodiment of the present disclosure. FIG. 21 is a cross-sectional view illustrating a window included in the display device of FIG. 20. FIG. 22 is an enlarged cross-sectional view of area A of FIG. 21. For example, FIG. 20 may correspond to the cross-sectional view of FIG. 3, and FIG. 21 may correspond to the cross-sectional view of FIG. 4.

Hereinafter, descriptions overlapping the window WD described with reference to FIGS. 1, 2, 3, 4, and 5 will be omitted or simplified.

Referring to FIG. 20, a display device 20 may include the substrate SUB, the display portion DP, the overcoating layer OC, and a window WD. The display device 20 may include the bending area BA, the boundary area SA, and the non-bending area NBA.

Referring to FIGS. 21 and 22, the window WD may include a base substrate BS and a coating layer CL. The base substrate BS may include a first surface S1 and a second surface S2 facing the first surface S1. In an embodiment, the first surface S1 may have a step, and the second surface S2 may be substantially flat.

In an embodiment, a thickness TH1 of the base substrate BS in the bending area BA may be thinner than a thickness TH2 of the base substrate BS in the non-bending area NBA. In addition, a width W of the boundary area SA of the base substrate BS may be about 1 mm to about 20 mm.

The first surface S1 of the base substrate BS may have a slope in the boundary area SA. For example, the first surface S1 of the base substrate BS may have the slope of about 0.10 to about 0.9° in the boundary area SA with respect to the first surface S1 of the base substrate BS in the bending area BA. In an embodiment, the slope may vary at least once. For example, the slope may vary twice.

In an embodiment, the boundary area SA may include a first area A1, a second area A2, and a third area A3. For example, the first area A1 may be an area adjacent to the bending area BA, the second area A2 may be an area adjacent to the non-bending area NBA, and the third area A3 may be an area located between the first area A1 and the second area A2. In other words, the third area A3 may be adjacent to the first area A1 in the first direction D1, and the second area A2 may be adjacent to the third area A3 in the first direction D1. The first area A1, the third area A3 and the second area A2 may be arranged in sequence.

The first surface S1 may have a first slope θ1 in the first area A1 with respect to the first surface S1 in the bending area BA. The first surface S1 may have a second slope θ2 in the second area A2 with respect to a line parallel to the first surface S1 in the bending area BA. The first surface S1 may have a third slope θ3 in the third area A3 with respect to a line parallel to the first surface S1 in the bending area BA.

In an embodiment, the third slope θ3 may be greater than each of the first slope θ1 and the second slope θ2. For example, the first slope θ1 and the second slope θ2 may be different from each other. As another example, the first slope θ1 and the second slope θ2 may be the same. Each of the first slope θ1, the second slope θ2, and the third slope θ3 may be about 0.10 to about 0.9°.

Since the third slope θ3 is greater than each of the first slope θ1 and the second slope θ2, a step between the thickness TH1 of the base substrate BS in the bending area BA and the thickness TH2 of the base substrate BS in the non-bending area NBA may not be relatively visually recognized. However, the present disclosure is not limited thereto. For example, the third slope θ3 may be smaller than the first slope θ1 or the second slope θ2.

A width W3 of the third area A3 of the base substrate BS may be greater than a sum of a width W1 of the first area A1 of the base substrate BS and a width W2 of the second area A2 of the base substrate BS. In other words, the width W3 of the third area A3 of the base substrate BS may be greater than the width W1 of the first area A1 of the base substrate BS and the width W2 of the second area A2 of the base substrate BS. For example, the width W1 of the first area A1 of the base substrate BS and the width W2 of the second area A2 of the base substrate BS may be different from each other. As another example, the width W1 of the first area A1 of the base substrate BS and the width W2 of the second area A2 of the base substrate BS may be the same.

In FIGS. 21 and 22, the first surface S1 is illustrated as having a cross-sectional shape in which the slope varies twice in the boundary area SA, but the present disclosure is not limited thereto. For example, the boundary area SA of the first surface S1 of the base substrate BS may have a cross-sectional shape in which a slope varies n (where n is a natural number) times, a cross-sectional shape of an exponential function, or the like.

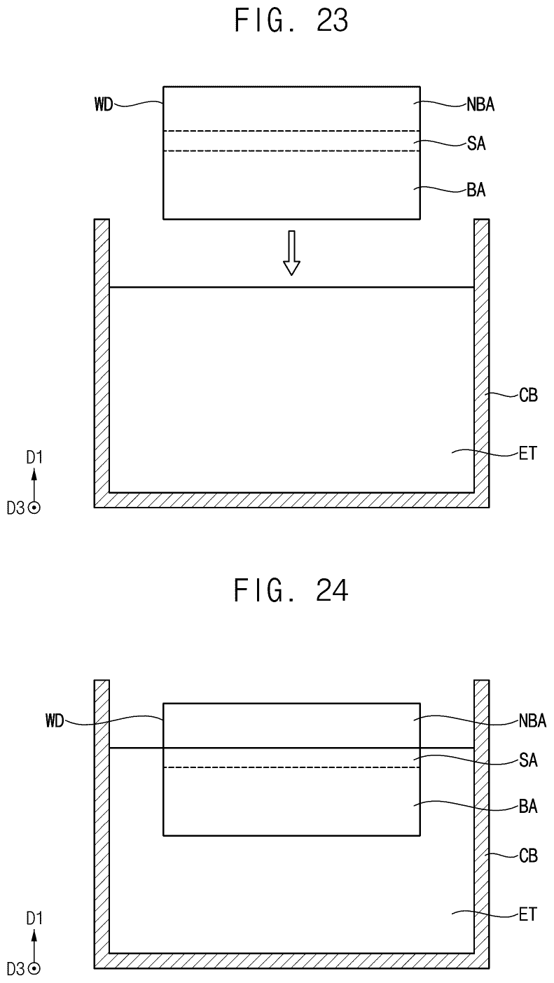

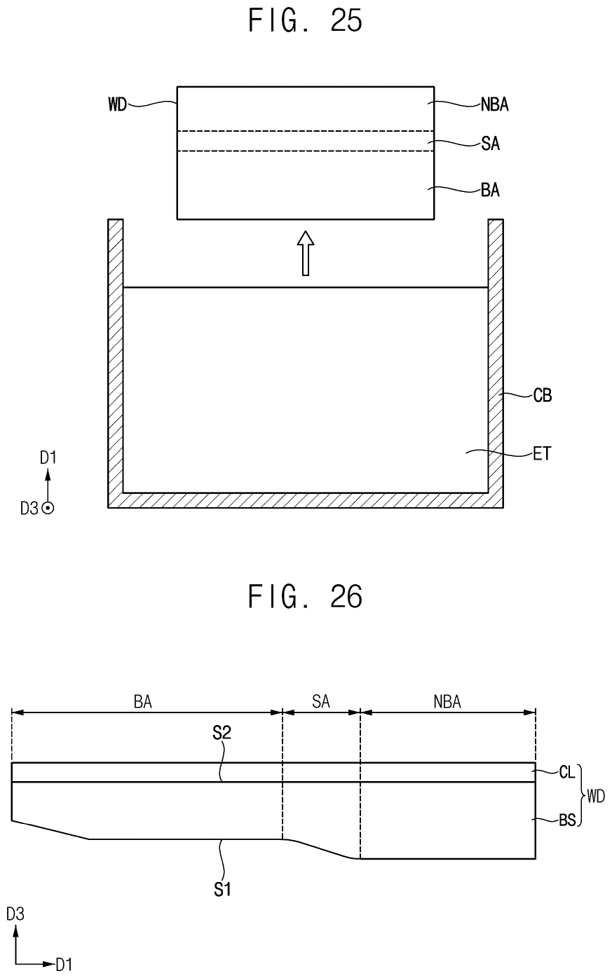

FIGS. 23, 24, 25, and 26 are views illustrating an embodiment of a method of manufacturing the window of FIG. 21.

Hereinafter, descriptions overlapping the methods of manufacturing the window WD described with reference to FIGS. 6 to 19 will be omitted or simplified.

Referring to FIGS. 23 and 24, the bending area BA and the boundary area SA of the window WD may be immersed in the etchant ET, and the non-bending area NBA of the window WD may not be immersed in the etchant ET.

Referring to FIGS. 24, 25, and 26, the window WD may be removed from the etchant ET.

For example, the window WD may be removed by being moved in the first direction D1 from the etchant ET. As another example, the window WD may be removed as the etchant ET is discharged from the chamber CB. As still another example, the window WD may be removed as the etchant ET flows into the chamber CB.

In an embodiment, a speed at which the boundary area SA of the window WD is removed from the etchant ET may be controlled. For example, the speed at which the boundary area SA of the window WD is removed may vary at least once. Accordingly, the first surface S1 of the base substrate BS may have the slope that varies at least once in the boundary area SA.

For example, the speed at which the boundary area SA of the window WD is removed may vary twice. Accordingly, the window WD in which the first surface S1 of the base substrate BS has the first, second and third slopes θ1, θ2, and θ3 that vary twice in the boundary area SA may be manufactured.

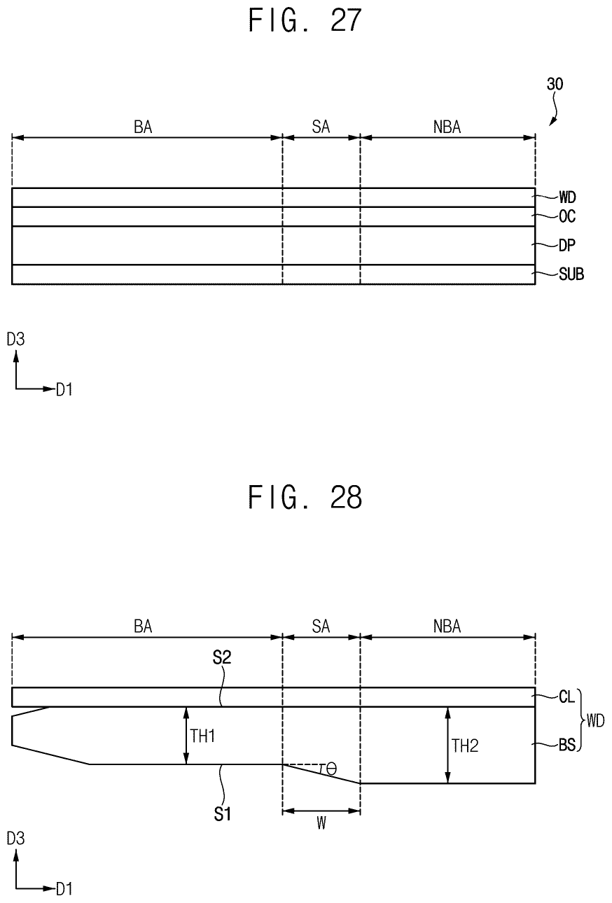

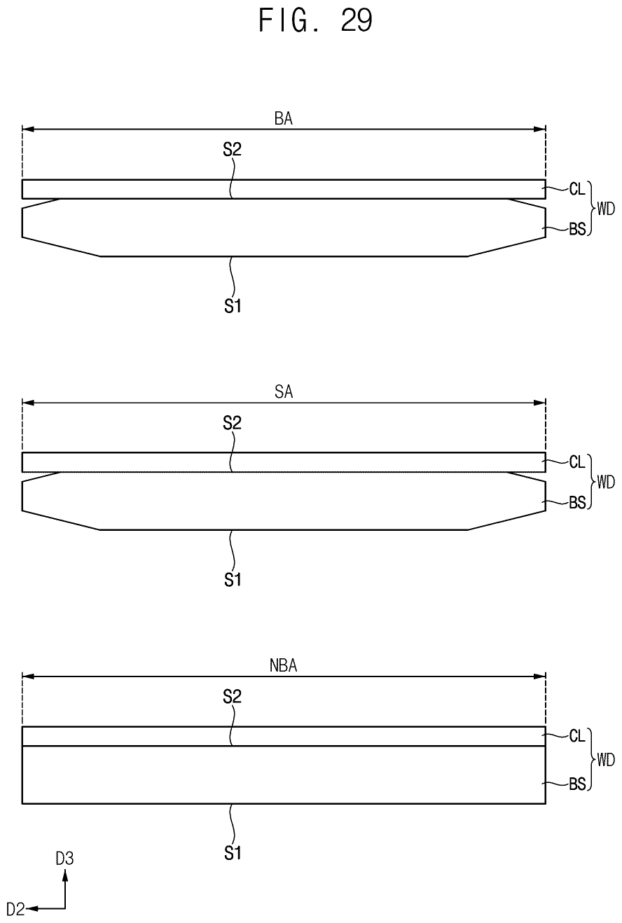

FIG. 27 is a cross-sectional view illustrating a display device according to still another embodiment of the present disclosure. FIGS. 28 and 29 are cross-sectional views illustrating a window included in the display device of FIG. 27. For example, FIG. 27 may correspond to the cross-sectional view of FIG. 3, FIG. 28 may correspond to the cross-sectional view of FIG. 4, and FIG. 29 may correspond to the cross-sectional view of FIG. 5.

Hereinafter, descriptions overlapping the window WD described with reference to FIGS. 1, 2, 3, 4, and 5 will be omitted or simplified.

Referring to FIG. 27, a display device 30 may include the substrate SUB, the display portion DP, the overcoating layer OC, and a window WD. The display device 30 may include the bending area BA, the boundary area SA, and the non-bending area NBA.

Referring to FIGS. 28 and 29, the window WD may include a base substrate BS and a coating layer CL. The base substrate BS may include a first surface S1 and a second surface S2 facing the first surface S1.

In an embodiment, a thickness TH1 of the base substrate BS in the bending area BA may be thinner than a thickness TH2 of the base substrate BS in the non-bending area NBA.

In an embodiment, a width W of the boundary area SA of the base substrate BS may be about 1 mm to about 20 mm. In addition, the first surface S1 of the base substrate BS may have a slope θ in the boundary area SA. For example, the first surface S1 of the base substrate BS may have the slope θ of about 0.1° to about 0.9° in the boundary area SA with respect to the first surface S1 in the bending area BA. The slope θ may be constant, or may vary at least once.

In an embodiment, an edge of each of the first surface S1 and the second surface S2 of the base substrate BS in the bending area BA and the boundary area SA may have a chamfered shape. For example, the chamfered shapes of the edge of the first surface S1 and the edge of the second surface S2 may be asymmetric. As another example, the chamfered shapes of the edge of the first surface S1 and the edge of the second surface S2 may be symmetrical. The chamfered shape of the edge of the second surface S2 may result in a gap being formed between the base substrate BS and the coating layer CL where the chamfered shape of the edge of the second surface S2 exists.

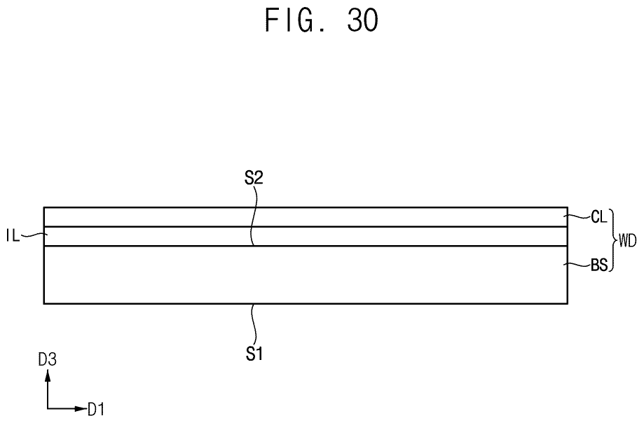

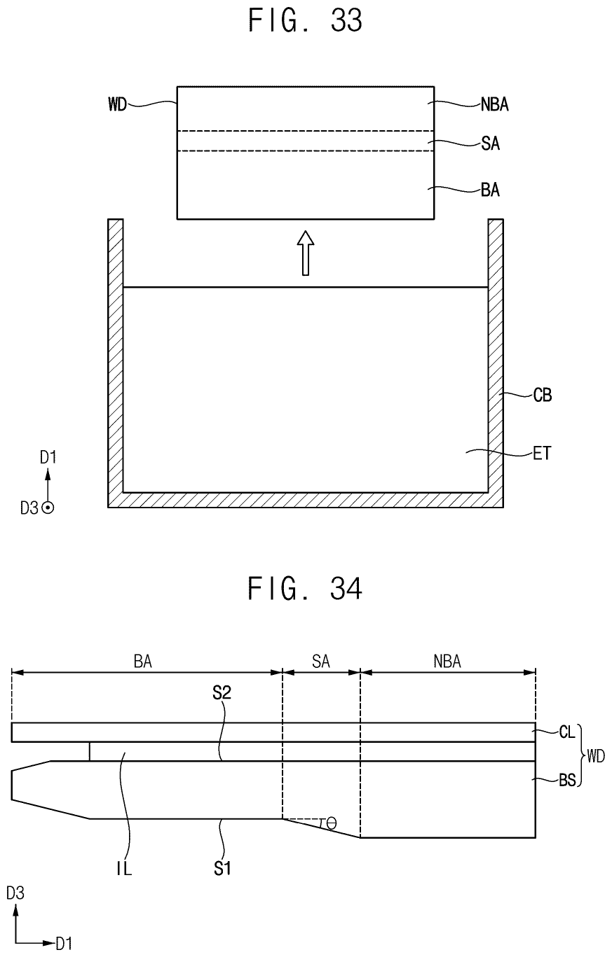

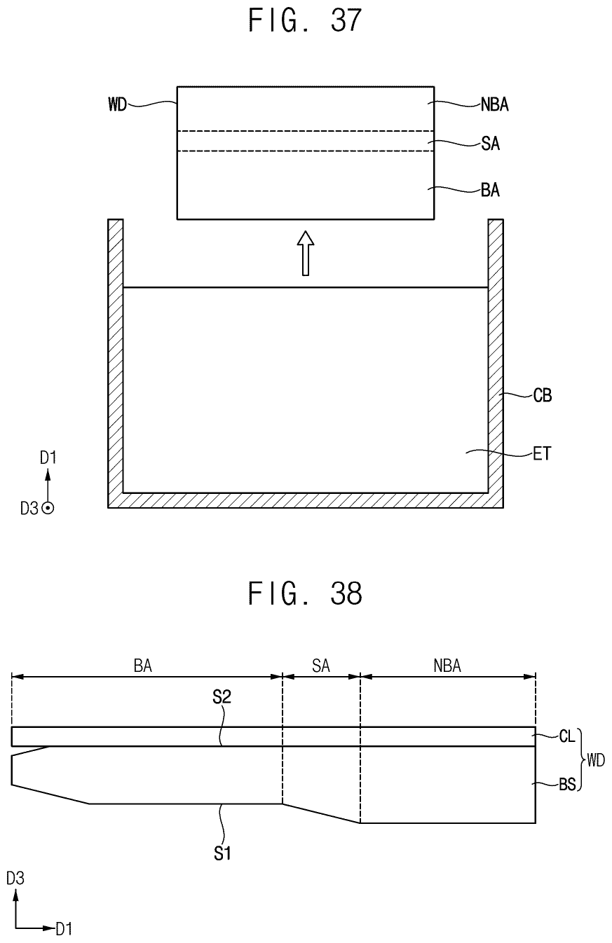

FIGS. 30, 31, 32, 33, 34, 35, 36, 37, and 38 are views illustrating an embodiment of a method of manufacturing the window of FIG. 27.

Hereinafter, descriptions overlapping the methods of manufacturing the window WD described with reference to FIGS. 6 to 19 will be omitted or simplified.

Referring to FIG. 30, an inorganic layer IL may be formed on the second surface S2 of the base substrate BS. The coating layer CL may be formed on the inorganic layer IL. An etching rate of the inorganic layer IL with respect to the etchant ET may be higher than an etching rate of the base substrate BS with respect to the etchant ET. Accordingly, the window WD including the base substrate BS and the coating layer CL may be formed.

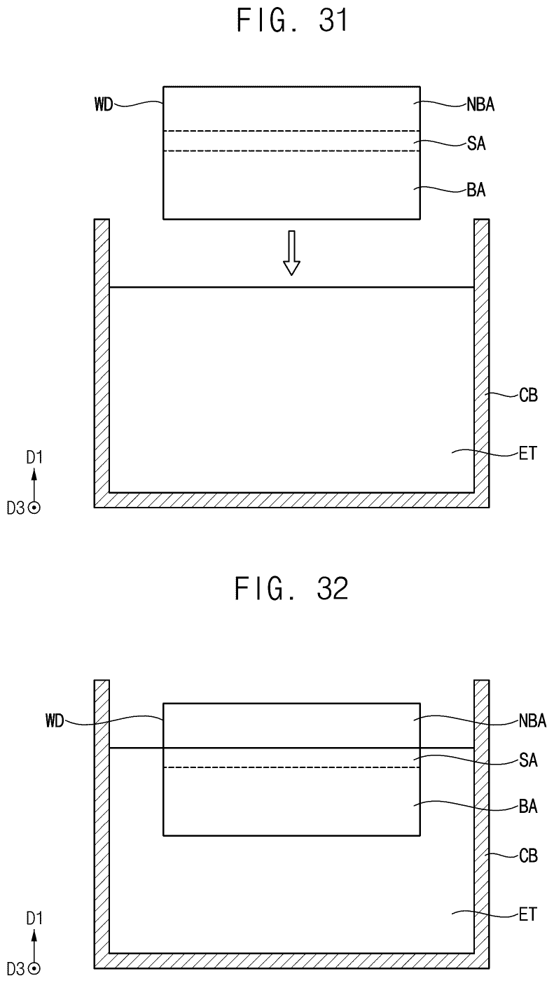

Referring to FIGS. 31, 32, and 33, the bending area BA and the boundary area SA of the window WD may be immersed in the etchant ET, and the non-bending area NBA of the window WD may not be immersed in the etchant ET.

Then, the window WD may be removed from the etchant ET. For example, the window WD may be removed by being moved in the first direction D1 from the etchant ET. As another example, the window WD may be removed as the etchant ET is discharged from the chamber CB. As still another example, the window WD may be removed as the etchant ET flows into the chamber CB.

In an embodiment, a speed at which the boundary area SA of the window WD is removed from the etchant ET may be controlled. The speed at which the window WD is removed may be constant, or may vary at least once.

Since the etching rate of the inorganic layer IL with respect to the etchant ET is relatively high, the inorganic layer IL may be etched, and at least a portion of the second surface S2 of the base substrate BS may be etched. Accordingly, the edge of each of the first surface S1 and the second surface S2 of the base substrate BS immersed in the etchant ET may be formed to have a chamfered shape. In other words, in the bending area BA and the boundary area SA, the edge of each of the first surface S1 and the second surface S2 of the base substrate BS may be etched to have the chamfered shape.

In an embodiment, an amount by which the edge of the first surface S1 is etched may be greater than an amount by which the edge of the second surface S2 is etched. However, the present disclosure is not limited thereto. For example, the amount by which the edge of the first surface S1 is etched may be equal to the amount by which the edge of the second surface S2 is etched.

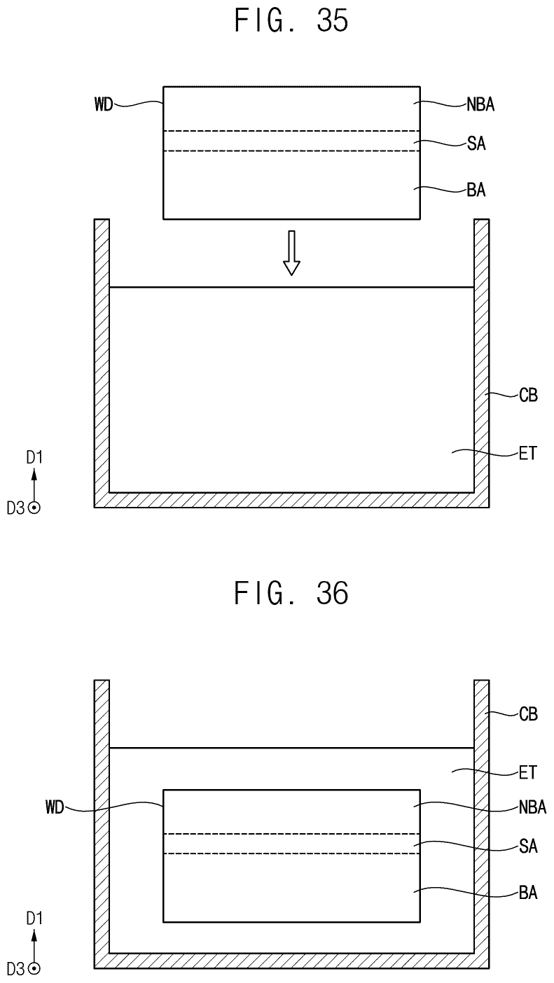

Referring to FIGS. 35, 36, 37, and 38, the window WD may be healed by being re-immersed in the etchant ET. In this case, the bending area BA, the boundary area SA, and the non-bending area NBA of the window WD may be entirely immersed in the etchant ET.

Since the window WD is healed, microcracks existing on surfaces of the non-bending area NBA of the window WD may be removed, and a strength of the non-bending area NBA of the window WD may be improved. In addition, since the etching rate of the inorganic layer IL with respect to the etchant ET is relatively high, the inorganic layer IL may be removed.

Accordingly, the edges of each of the first surface S1 and the second surface S2 of the bending area BA and the boundary area SA of the base substrate BS have a chamfered shape. Therefore, a window WD may be manufactured.

Accordingly, the window WD in which the edge of each of the first surface S1 and the second surface S2 of the bending area BA and the boundary area SA of the base substrate BS have the chamfered shape may be manufactured.

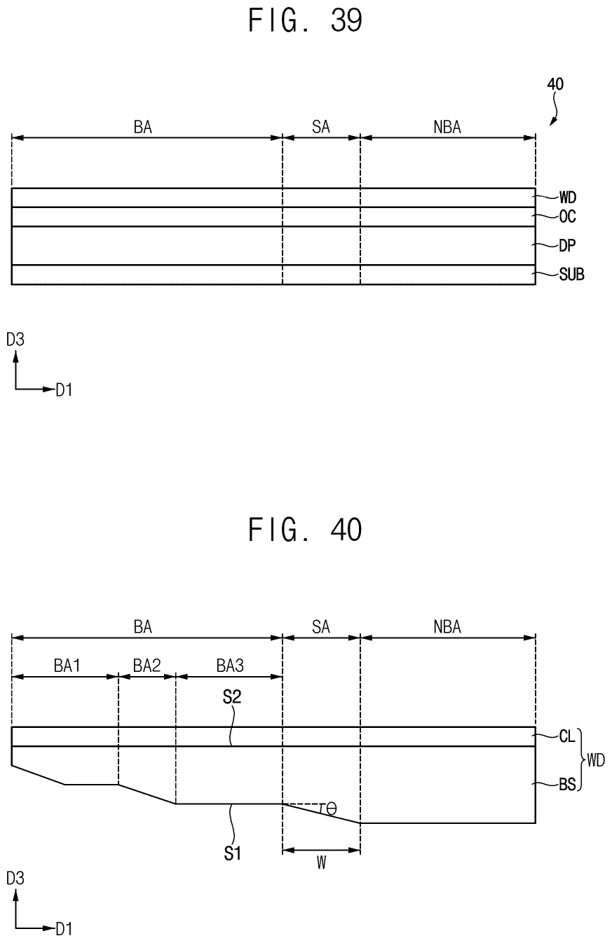

FIG. 39 is a cross-sectional view illustrating a display device according to still another embodiment of the present disclosure. FIG. 40 is a cross-sectional view illustrating a window included in the display device of FIG. 39. For example, FIG. 39 may correspond to the cross-sectional view of FIG. 4.

Hereinafter, descriptions overlapping the window WD described with reference to FIGS. 1, 2, 3, 4, and 5 will be omitted or simplified.

Referring to FIG. 39, a display device 40 may include the substrate SUB, the display portion DP, the overcoating layer OC, and a window WD. The display device 40 may include the bending area BA, the boundary area SA, and the non-bending area NBA.

Referring to FIG. 40, the window WD may include a base substrate BS and a coating layer CL. The base substrate BS may include a first surface S1 and a second surface S2 facing the first surface S1. In an embodiment, the first surface S1 may have a step, and the second surface S2 may be substantially flat.

In an embodiment, a thickness of the base substrate BS in the bending area BA may be thinner than a thickness of the base substrate BS in the non-bending area NBA. In addition, a width W of the boundary area SA of the base substrate BS may be about 1 mm to about 20 mm.

In an embodiment, the bending area BA may include a first bending area BA1, a second bending area BA2, and a third bending area BA3. The first, second, and third bending areas BA1, BA2, and BA3 may be arranged in sequence along the first direction D1. A thickness of the first bending area BA1 of the base substrate BS may be thinner than a thickness of the third bending area BA3 of the base substrate BS. A thickness of the second bending area BA2 of the base substrate BS may be greater than the thickness of the first bending area BA1 of the base substrate BS. The thickness of the second bending area BA2 of the base substrate BS may be less than the thickness of the third bending area BA3 of the base substrate BS. The first surface S1 of the base substrate BS may have a slope in the second bending area BA2.

Since the first surface S1 has the slope in the bending area BA, a thickness of an area where bending starts may be relatively thin. In other words, since the thickness of the first bending area BA1 is relatively thin, a repulsive force generated when the window WD is bent may be reduced.

In FIG. 40, the bending area BA is illustrated as having one slope, but the present disclosure is not limited thereto. For example, the bending area BA may have two or more slopes.

In an embodiment, the first surface S1 of the base substrate BS may have a slope in the boundary area SA. For example, the first surface S1 of the base substrate BS may have the slope θ of about 0.1° to about 0.9° in the boundary area SA with respect to the first surface S1 of the base substrate BS in the third bending area BA3. The slope θ may be constant, or may vary at least once.

The present disclosure can be applied to various display devices. For example, the present disclosure is applicable to various display devices such as display devices for vehicles, ships and aircraft, portable communication devices, display devices for exhibition or information transmission, medical display devices, and the like.

The foregoing is illustrative of embodiments of the present disclosure and is not to be construed as limiting thereof. Although a few embodiments have been described, those skilled in the art will readily appreciate that many modifications are possible in the embodiments without materially departing from the teachings of the present disclosure. Accordingly, all such modifications are intended to be included within the scope of the present disclosure as set forth in the claims.

What is claimed is:

1. A display device comprising:
a substrate including a bending area, a boundary area adjacent to the bending area, and a non-bending area adjacent to the boundary area; and
a window disposed on the substrate and including:
a base substrate including a first surface having a slope of about 0.1° to about 0.9° in the boundary area with respect to the first surface in the bending area, wherein the base substrate has a thickness in the bending area that is less than its thickness in the non-bending area; and
a coating layer disposed on a second surface of the base substrate, wherein the second surface faces the first surface of the base substrate.

2. The display device of claim 1, wherein a width of the window in the boundary area is about 1 mm to about 20 mm.

3. The display device of claim 1, wherein an edge of at least one of the first surface and the second surface of the base substrate has a chamfered shape in the bending area and the boundary area.

4. The display device of claim 1, wherein the slope of the first surface of the base substrate is constant in the boundary area.

5. The display device of claim 1, wherein the slope of the first surface of the base substrate varies at least once in the boundary area.

6. The display device of claim 5, wherein the boundary area includes a first area adjacent to the bending area, a second area adjacent to the non-bending area, and a third area between the first area and the second area, and
a slope of the third area of the base substrate is greater than a slope of each of the first area and the second area of the base substrate.

7. The display device of claim 6, wherein a width of the window in the third area is greater than a sum of a width of the window in the first area and a width of the window in the second area.

8. A method of manufacturing a window, the method comprising:
immersing a bending area and a boundary area of a base substrate into an etchant, wherein the boundary area is adjacent to the bending area and the boundary area is adjacent to a non-bending area of the base substrate; and
removing the base substrate from the etchant so that a first surface of the base substrate has a slope in the boundary area.

9. The method of claim 8, wherein the removing of the base substrate includes:
forming an edge of at least one of the first surface and a second surface of the base substrate facing the first surface to have a chamfered shape in the bending area and the boundary area.

10. The method of claim 8, wherein the first surface is formed to have the slope of about 0.10 to about 0.9° in the boundary area with respect to the first surface in the bending area.

11. The method of claim 8, wherein a width of the boundary area is formed to be about 1 mm to about 20 mm.

12. The method of claim 8, wherein in the removing of the base substrate,
a speed of removing the boundary area of the base substrate from the etchant is constant.

13. The method of claim 8, wherein in the removing of the base substrate,
a speed of removing the boundary area of the base substrate from the etchant varies at least once.

14. The method of claim 13, wherein the boundary area includes a first area adjacent to the bending area, a second area adjacent to the non-bending area, and a third area between the first area and the second area, and
a slope of the third area is formed to be greater than a slope of each of the first area and the second area.

15. The method of claim 14, wherein a width of the third area is formed to be greater than a sum of a width of the first area and a width of the second area.

16. The method of claim 8, wherein the removing of the base substrate includes:
discharging or flowing the etchant.

17. The method of claim 8, wherein in the immersing of the bending area and the boundary area of the base substrate in the etchant,
the base substrate is tilted and immersed.

18. The method of claim 8, further comprising:
forming a coating layer on a second surface of the base substrate facing the first surface of the base substrate before the immersing of the bending area and the boundary area of the base substrate in the etchant.

19. The method of claim 18, further comprising:
forming an inorganic layer between the second surface and the coating layer before the immersing of the bending area and the boundary area of the base substrate in the etchant.

20. The method of claim 8, further comprising:
healing the bending area, the boundary area, and the non-bending area of the base substrate by immersing the bending area, the boundary area, and the non-bending area of the base substrate in the etchant.
